(19) United States
(12) Patent Application Publication
(10) Pub. No.: US 2007/0234866 A1
(43) Pub. Date: Oct. 11, 2007

(54) PUNCH WITH ADJUSTABLE PUNCH PAD

(75) Inventors: Balaji Kandasamy, Naperville, IL (US); Joy Pineres, Gurnee, IL (US); Steve McPhilliamy, Chicago, IL (US); Chad Davis, Chicago, IL (US)

Correspondence Address: MICHAEL BEST & FRIEDRICH LLP, 100 E WISCONSIN AVENUE, Suite 3300, MILWAUKEE, WI, 53202, US

(73) Assignee: ACCO BRANDS USA LLC, Lincolnshire, IL (US)

(21) Appl. No.: 11/535,140

(22) Filed: Sep. 26, 2006

Related U.S. Application Data
(60) Provisional application No. 60/720,510, filed on Sep. 26, 2005.

(51) Int. Cl. B26D 5/08

(52) U.S. Cl. 83/588

(57) ABSTRACT

A punch includes punch pads that are easily and conveniently adjustable by a user. The punch includes a base and a punch head coupled to the base. The punch head includes a punch pin configured to move in a punching direction. An adjustable punch pad is mounted to the punch. The adjustable punch pad includes a receiving surface for receiving the punch pin. An actuator is coupled to at least one of the punch pads to move the punch pad.

### RELATED APPLICATIONS

This application claims priority to U.S. Provisional Application No. 60/720,510 filed Sep. 26, 2005, the entire content of which is hereby incorporated by reference.

### FIELD OF THE INVENTION

The invention relates to punches. More specifically, the invention relates to punches having an adjustable punch pad.

### BACKGROUND OF THE INVENTION

Paper punches are known that allow a user to punch holes in a stack of paper sheets (or other materials) at predetermined locations to allow the sheets to be placed onto rings, prongs or other securing devices in a binder or folder. The punches include a punch head, which houses a punch pin that is actuated to punch a hole in the sheets. Some types of punches utilize a solid punch pin such that the bits of paper that are punched out, known as chads or chips, fall through a hole into a collection receptacle. In other types of punches, hollow punch pins that have a cavity within the pin are utilized such that the chads are forced into the cavity of the pin after punching.

In punches utilizing hollow pins, it is known to provide a punch pad or other support surface below the pin against which the punching force is applied to cut the paper. The force of the pin against the support surface can wear out portions of the support surface after some usage if the support surface is not adjusted periodically to spread out the contact across the support surface. In particular, the sharp cutting edge of the punch pin can leave circular impressions on the support surface if the punch pin contacts the same portion of the support surface repeatedly.

### SUMMARY OF THE INVENTION

It is desirable to provide a punch having one or more support surfaces that are easily adjustable by the user to ensure that the support surfaces are adjusted regularly to prevent excessive wearing of the support surfaces. Prior art methods of adjusting the support surfaces have been inconvenient for users to perform, resulting in support surfaces that do not get adjusted properly and thus wear out prematurely. Additionally, users also do not know to adjust the support surfaces, or simply do not remember to periodically adjust the support surfaces to promote even wear. Further, prior art methods and apparatus often require the user to place their fingers directly on the punch pads to adjust the punch pads.

The present invention provides an improved punch that includes punch pads that are easily and conveniently adjustable by a user. The punch includes a base and a punch head coupled to the base. The punch head includes a punch pin configured to move in a punching direction. An adjustable punch pad is mounted to the punch. The adjustable punch pad includes a receiving surface for receiving the punch pin. An actuator is coupled to at least one of the punch pads to move the punch pad.

In one embodiment of the invention, the punch pin is a hollow punch pin. In another embodiment, the punch includes a handle coupled to the base for moving the punch pin in the punching direction. In yet another embodiment, the receiving surface is substantially planar.

In another aspect of the invention, the actuator includes an adjustment bar that cooperates with the punch pad. In one embodiment, the adjustment bar is movable linearly. In another embodiment, the punch includes a plurality of punch pads and the adjustment bar engages all of the punch pads. In one embodiment, the adjustment bar is manually movable, and in another embodiment, the adjustment bar is automatically movable. In another embodiment, the adjustment bar is coupled to a sliding lever, and sliding the lever results in movement of the adjustment bar. In yet another embodiment, the punch further comprises a spring that biases the adjustment bar such that after the punch pad is moved in a first direction, the adjustment bar is disengaged from the punch pad such that the punch pad does not move in a second direction opposite the first direction. In yet another embodiment, the receiving surface is movable in a plane that is perpendicular to the movement of the punch pin.

Other features and advantages of the invention will become apparent to those skilled in the art upon review of the following detailed description and drawings.

### BRIEF DESCRIPTION OF THE DRAWINGS

FIG. 1 is a perspective view of a punch according to the present invention, with a punch cover rotated up to expose the punch pads.

FIG. 2 is a bottom perspective view of the punch of FIG. 1.

FIG. 3 is a side view of the punch of FIG. 1.

FIG. 4 is a front view of the punch of FIG. 1.

FIG. 5 is a perspective view of the punch of FIG. 1 with portions of the punch removed to illustrate the punch pads and punch heads in detail.

FIG. 6 is a rear perspective view of the punch of FIG. 5.

FIG. 7 is a perspective view of the punch of FIG. 1 with additional portions of the punch removed to illustrate a stop member coupled to the punch pads.

FIG. 8 is a perspective view of the punch of FIG. 1 with the punch cover rotated down.

FIG. 9 is a perspective view of a punch according to a second embodiment of the invention, with portions of the punch removed to illustrate the punch pads and punch heads in detail.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including”, “having”, and “comprising” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

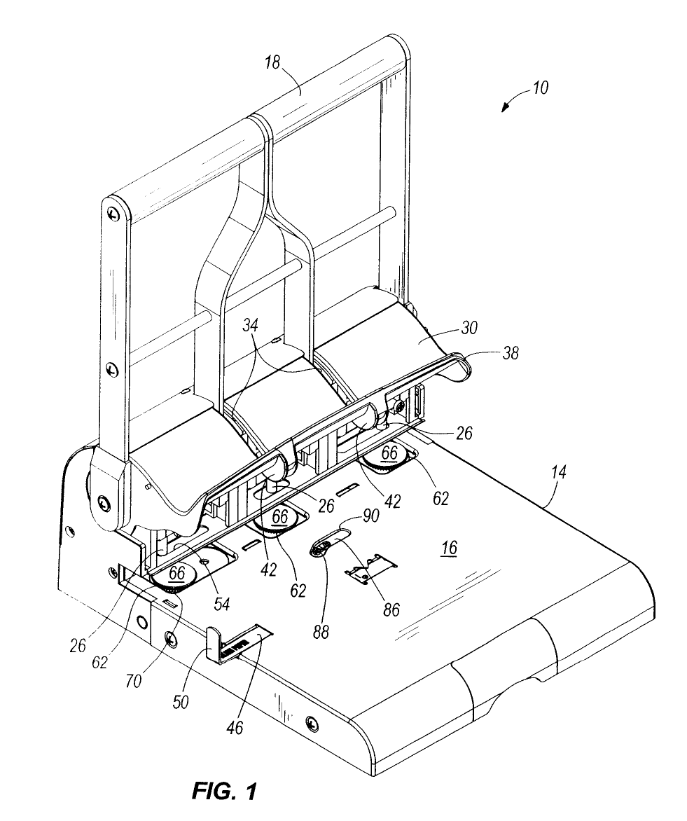

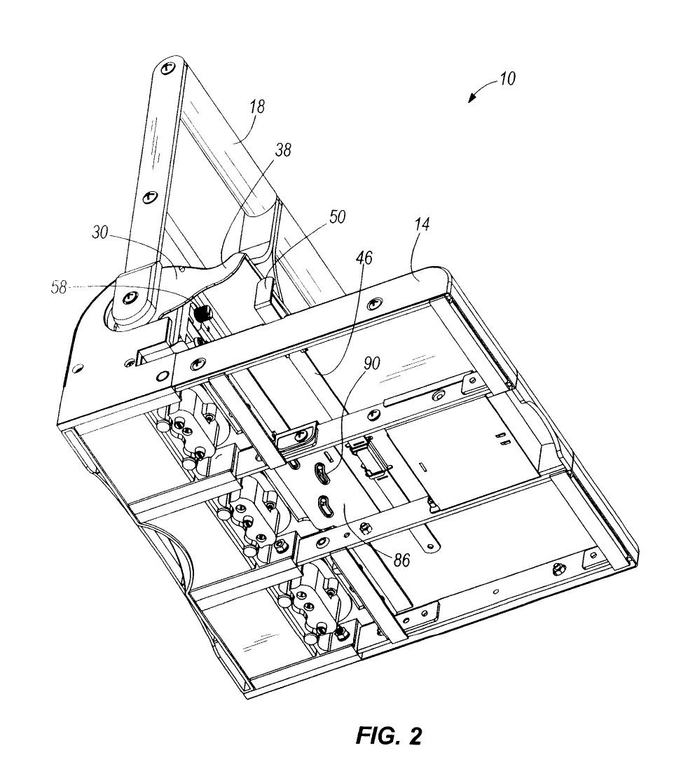

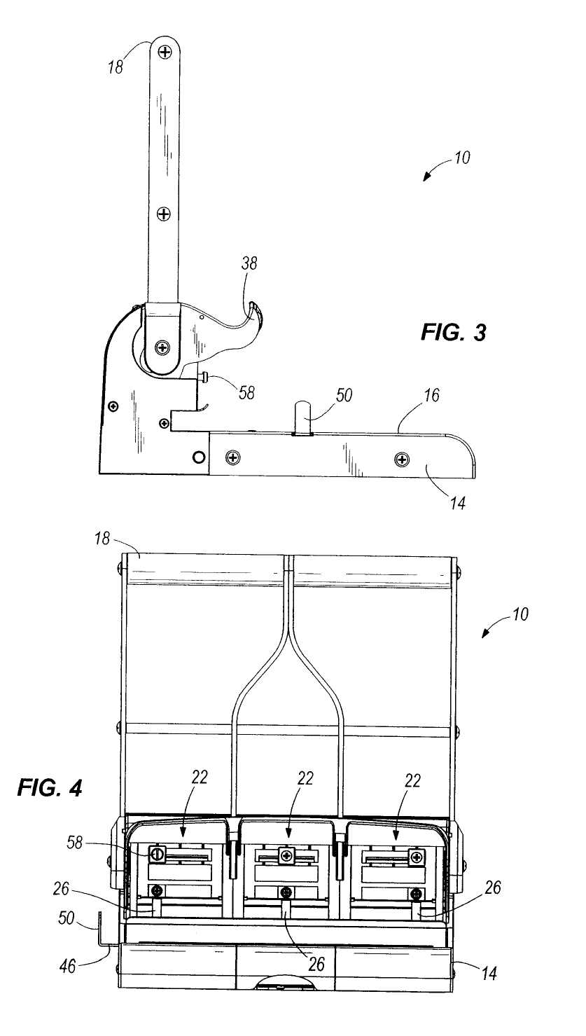

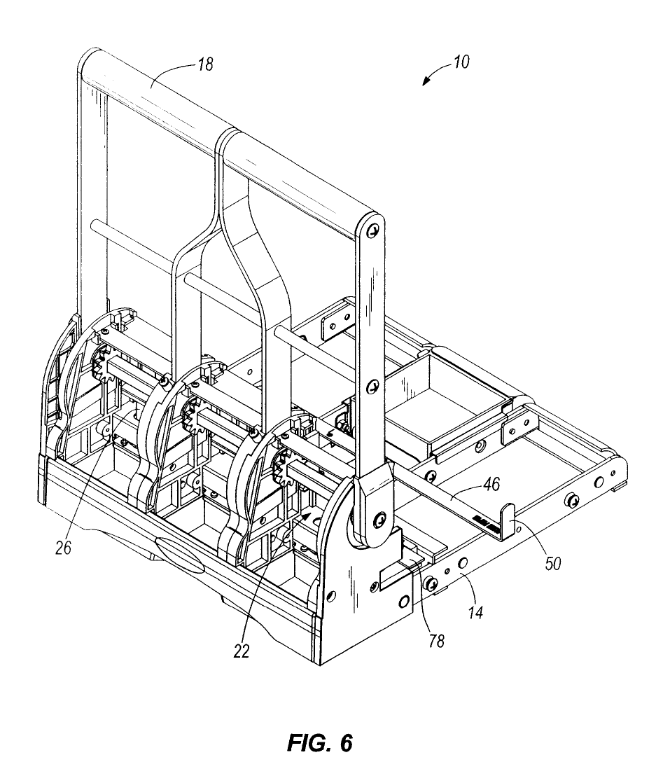

FIGS. 1-8 illustrate a punch 10 according to the invention. The punch 10 includes a base 14 and a handle 18 coupled to the base 14 for operating the punch 10. The base 14 is configured to support a stack of sheets (not shown) inserted within the punch 10 to be acted upon by the punch 10, and includes an upper surface 16 that defines a plane. A plurality of punch heads 22 are coupled to the base 14. In the illustrated embodiment, the punch 10 includes three punch heads 22, though it is understood that more or fewer punch heads, such as four punch heads, one punch head, or two punch heads, could be used and still fall within the scope of the invention. While the illustrated punch is a manually-operated punch, the present invention can also be embodied in an electric punch, which may not include a handle, but may include a button or other means to automatically actuate the punch.

Each punch head 22 includes a punch pin 26 configured to move in a punching direction. In the illustrated embodiment, the punching direction is perpendicular to the stack of sheets supported by the base 14. The handle 18 is rotatably coupled to the base 14 such that rotation of the handle 18 from the position shown in FIG. 1, where the handle 18 is generally perpendicular to the base 14, to a position generally parallel to the base 14 moves the punch pins 26 in the punching direction. In the illustrated embodiment, the punch pins 26 are hollow pins, though it is understood that in other embodiments, a solid punch pin can be used and still fall within the scope of the present invention. One configuration of a hollow punch pin is described and illustrated in U.S. Pat. No. 5,730,038, issued Mar. 24, 1998, the entire content of which is incorporated by reference herein.

The illustrated punch 10 also includes a cover 30 coupled to the base 14. The cover 30 protects the punch heads 22 during the punching operation, and includes slots 34 therein for receiving portions of the handle 18. A flared portion 38 includes downwardly extending paper guides 42 that assist in guiding the sheets into the punch 10. In the illustrated embodiment, the cover 30 is rotatable with respect to the base 14 (see FIGS. 1 and 8).

An adjustable paper guide 46 is also coupled to the base 14. The paper guide 46 includes a tab 50 that extends upwardly from the base 14. The tab 50 receives an edge of the stack of sheets inserted into the punch to assist the user in aligning the stack of sheets to receive the punch pins 26 during punching to produce the desired punch positioning in the sheets.

It is also understood that the punch spacing can be adjusted by varying the location of the punch heads 22 on the base 14. At least one of the punch heads 22 of the illustrated embodiment can be moved laterally along the base 14. As such, the base 14 includes one or more slots 54 that accommodate the punch pins 26 in varying positions about the width of the base 14. The punch heads 22, and thus the punch pins 26, can be adjusted in known manners, such as by adjusting a screw 58 (see FIG. 4).

A plurality of adjustable punch pads 62 are also mounted to the base 14. The number of punch pads 62 preferably corresponds to the number of punch pins 26 present in the punch 10, however this need not be the case. The position of at least one of the punch pads 62 is variable to correspond with the punch pin 26 spacing. The punch pads 62 each include a punch pin receiving surface 66. In the illustrated embodiment and as best shown in FIG. 1, the receiving surfaces 66 of the punch pads 62 are substantially planar and are substantially co-planar with the plane defined by the upper surface 16 of the base, however, this need not be the case. The receiving surfaces 66 also lie in a plane that is perpendicular to the direction of punch pin 26 movement during punching operations. The punch pads 62 and their respective receiving surfaces 66 are movable in a plane that is perpendicular to the movement of the punch pins 26 in the punching direction.

As shown in the illustrated embodiment, the punch pads 62 are substantially circular in configuration, and include teeth 70 spaced about the circumferential edge of the punch pads 62. It is understood that other configurations of the punch pads are possible and still fall within the scope of the invention.

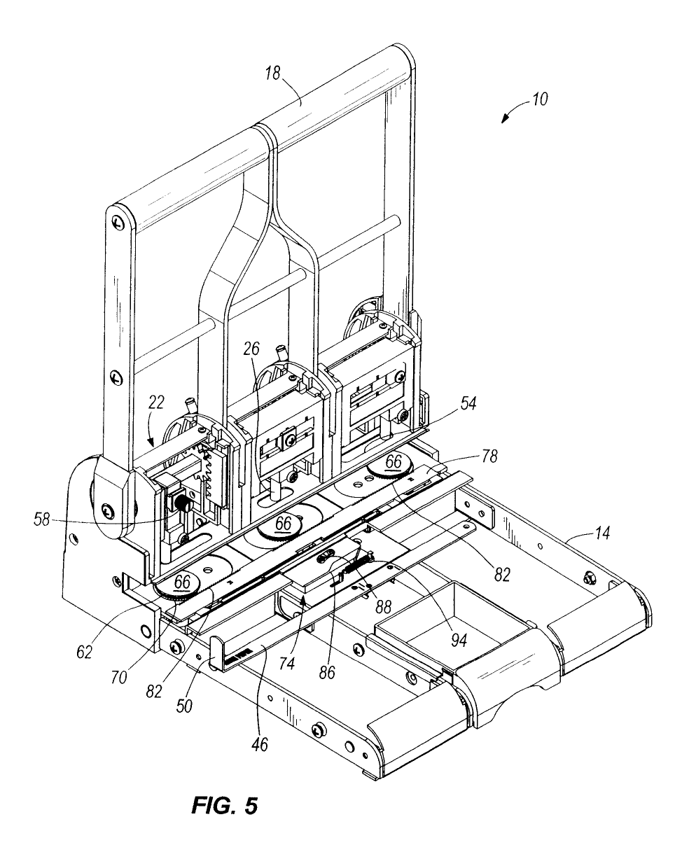

As best illustrated in FIG. 5, the punch 10 also includes an actuator 74 coupled to the base 14. The actuator 74 engages and acts upon at least one of the punch pads 62. In the illustrated embodiment, the actuator 74 engages and acts upon all three punch pads 62 simultaneously, though it is understood that in other embodiments, the actuator 74 can act upon only some of the punch pads 62, or can act on the punch pads 62 one at a time.

The actuator 74 includes an adjustment bar 78 that extends at least partially across the width of the base 14. The adjustment bar 78 includes teeth 82 that cooperate with the teeth 70 of the punch pads 62 such that movement of the adjustment bar 78 results in movement of the punch pads 62. The adjustment bar 78 is movable linearly across the width of the base 14 and in the illustrated embodiment, the adjustment bar 78 engages and rotates all three punch pads 62. In other embodiments, the adjustment bar 78 may only engage one or some of the punch pads 62.

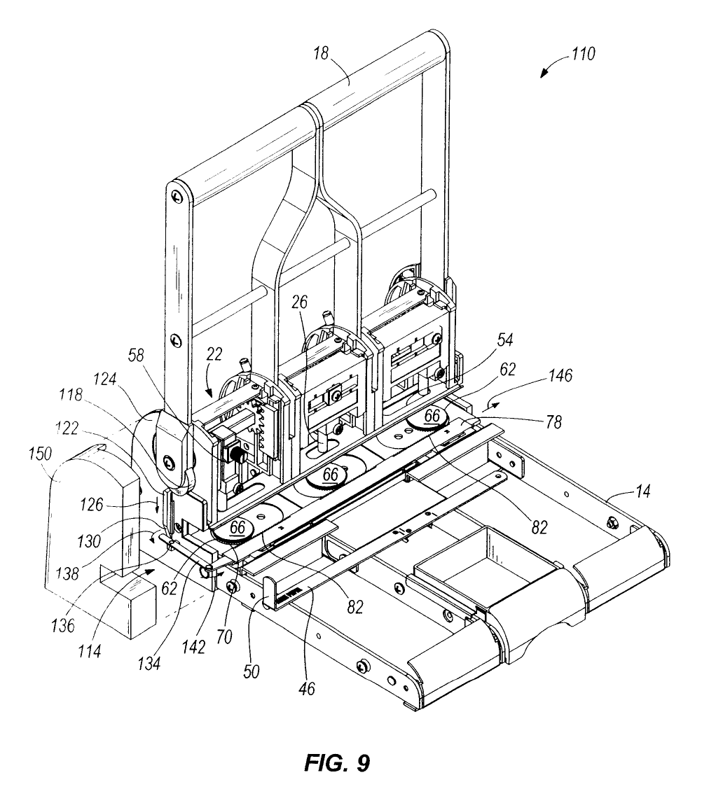

The actuator 74 also includes a sliding lever 86 coupled to the adjustment bar 78 and that is movable by the user of the punch 10 to effect rotation of the punch pads 62 in the plane of rotation. Thus, in the illustrated embodiment, the actuator 74, and thus the adjustment bar 78 and the punch pads 62, is manually adjustable. It is understood that in other embodiments, the punch 10 could employ a linkage, a motor, or other means to automatically adjust the position of the punch pads 62 and still fall within the scope of the invention. For example, movement of a portion of the punch 10 during the punching operation, such as movement of the handle 18, the punch pins 26, or an intermediate linkage could provide the drive to automatically adjust the position of the punch pads 62 (e.g., by causing movement of the adjustment bar 78 or other drive input member). In an electric punch, a linkage could tie operation of the drive motor or punch pins to adjustment of the punch pads for automatic adjustment. Alternatively, the drive motor could directly drive the automatic adjustment of the punch pads. One example of such a punch with automatic adjustment of the punch pads is described below with respect to FIG. 9.

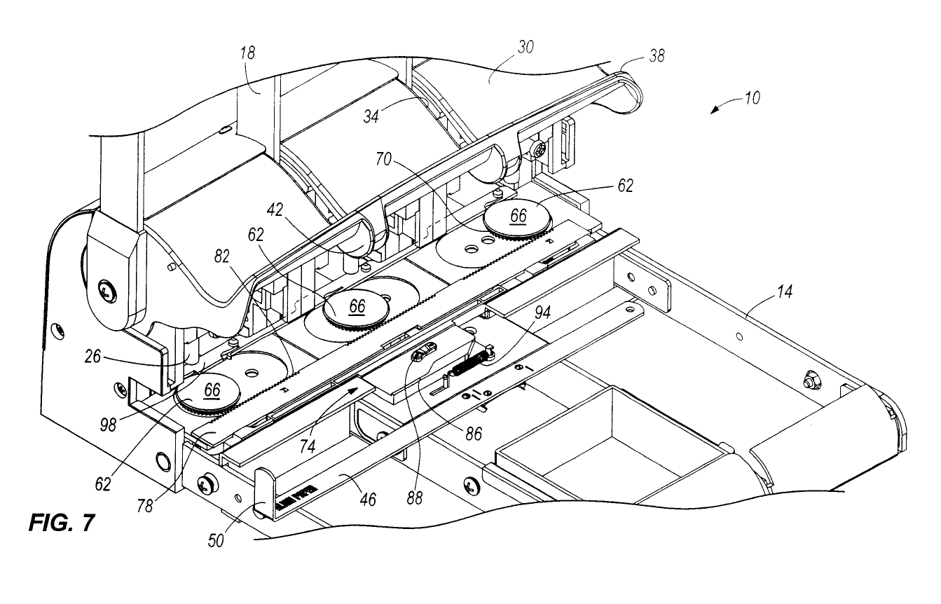

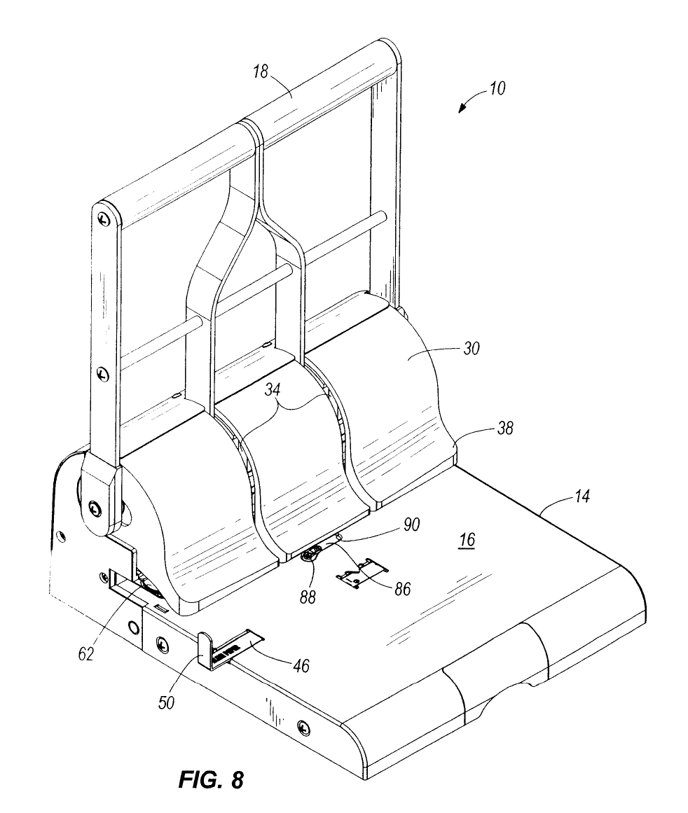

The lever 86 includes a projection 88 engageable by the finger or thumb of the user and that moves within an aperture 90 in the top surface 16 of the base 14. The actuator 74 also includes a spring 94 that biases the adjustment bar 78 in a manner that will be described in more detail below. As shown in FIG. 7, a stop member 98 is coupled to the base 14 and engages with the teeth 70 of the punch pads 62 as will be described below.

The punch 10 described in detail above can be operated according to the following method. To actuate the punch 10, the user grasps the handle 18 and rotates the handle 18 from the generally perpendicular position shown in FIG. 1 downwardly toward the base 14. The rotation of the handle 18 actuates the punch pins 26, lowering the punch pins 26 such that the punch pins 26 punch out a portion of the stack of sheets inserted within the punch 10. The chads or chips that are punched out of the stack of sheets are forced up into the hollow punch pins 26, and the cutting edge of the punch pins 26 contacts the receiving surfaces 66 of the punch pads 62. Once the punch is complete, the user releases the handle 18, and the handle 18 rotates back to the position of FIG. 1.

In order to ensure even wear across the receiving surfaces 66, the user periodically adjusts the punch pads 62 such that a fresh portion of the receiving surfaces 66 is in position to be contacted by the cutting edge of the punch pins 26 during a later punch operation. To adjust the punch pads 62, the user slides the lever 86 from left to right (as viewed in FIG. 1) using the projection 88 in an adjustment stroke. The projection 88 moves within the aperture 90. The lever 86 is coupled to the adjustment bar 78 such that the lever 86 and the adjustment bar 78 move in tandem. The teeth 82 of the adjustment bar 78 mesh with the teeth 70 of the punch pads 62 such that the linear movement of the adjustment bar 78 is translated into rotational motion of the punch pads 62. In the illustrated embodiment, the punch pads 62 are rotated counterclockwise in incremental fashion due to meshing of the teeth 82, 70.

At the end of the linear adjustment stroke of the adjustment bar 78, the spring 94 biases the adjustment bar 78 away from the punch pads 62 such that the teeth 82, 70 disengage. The spring 94 also biases the adjustment bar 78 toward the rest position. The disengagement of the teeth allows the adjustment bar 78 to return to the rest position (FIG. 1) without causing counter-rotation of the punch pads 62 (i.e., the disengagement prevents clockwise rotation of the punch pads 62). Additionally, the engagement of the stop member 98 with the teeth 70 of the punch pads 62 further prevents clockwise rotation of the punch pads 62 during the return stroke. Any counter-rotation would be counterproductive to the actuator 74, as counter-rotation of the punch pads 62 would cause the same portion of the receiving surfaces 66 to be in position for contact with the punch pins 26 during each punch, causing uneven wear of the receiving surfaces 66.

The configuration of the aperture 90 in the base 14 allows for some relative movement of the lever 86 during the return stroke (i.e., movement of the adjustment bar 78 from right to left when viewed from the front) to disengage the adjustment bar 78 from the punch pads 62. The force directed into the lever 86 during the adjustment stroke by the user overcomes the bias of the spring 94 to allow the adjustment bar 78 to engage the punch pads 62, and the bias of the spring 94 causes the adjustment bar 78 to disengage the punch pads 62 and return to rest during the return stroke.

The user can adjust the punch pads 62 via the method described above as desired (e.g., after each punch operation or intermittently) to help ensure even wearing of the punch pads 62, thereby maximizing the life of the punch pads 62 and punch pins 26. In the case of a punch incorporating automatic punch pad adjustment as described above, such automatic adjustment could occur with each punching cycle (e.g., in the case where adjustment is linked to movement or operation of punch structure in a manual punch, like the punch 110 of FIG. 9, or in an electric punch), or intermittently after a number of cycles (e.g., by incorporating appropriate timing devices or circuitry).

FIG. 9 illustrates a second embodiment of a punch 110. Most of the components of the punch 110 are the same as or similar to the components of the punch 10, and have been given like reference numbers. However, instead of including the lever 86 and associated structure for manual adjustment by a user, the punch 110 is configured to automatically adjust the punch pads 62 upon operation of the punch (e.g., as a result of moving the handle 18 to cause punch operation).

In the embodiment illustrated in FIG. 9, a linkage 114 transmits power from the handle 18 to the adjustment bar 78 to rotate the punch pads 62. Specifically, a portion of the handle 18 includes a cam lobe 118 configured to engage and move a first link 122 that is mounted on a vertical frame portion 124 of the punch 110 in the direction of arrow 126. The first link 122 is spring biased toward the position illustrated in FIG. 9 by a biasing mechanism (not shown). The first link 122 includes a ramped surface 130 that engages a second link 134, which is pivotably coupled with the vertical frame portion 124 via pivot 136. As the first link 122 moves downwardly, the ramped surface 130 causes the adjacent end of the second link 134 to move in the direction of arrow 138. An opposite end of the second link 134 is coupled to the adjustment bar 78 such that pivoting of the second link 134 causes the opposite end of the second link 134 to move in the direction of arrow 142, thereby causing the adjustment bar 78 to move in the direction of arrow 146. This movement of the adjustment bar 78 causes the teeth 82 on the adjustment bar 78 to cooperate with the teeth 70 of the punch pads 62 to move the punch pads 62 in the same manner described above for punch 10. The return motion of the adjustment bar 78 and the disengagement of the teeth 82 and the teeth 70 can occur in the same manner discussed above with respect to the punch 10. A cover member 150 can be positioned on the vertical frame portion 124 to conceal the linkage 114.

The punch 110 illustrated in FIG. 9 illustrates only one example of a punch that is operable to automatically adjust the punch pads 62. As mentioned above, different types of linkages can be substituted for the illustrated linkage 114. Additionally, other punches can be configured to automatically adjust the punch pads either during each punching operation, or intermittently.

Various features of the invention can be found in the following claims.

We claim:

1. A punch comprising:
a base;
a punch head coupled to the base, the punch head including a punch pin configured to move in a punching direction;
an adjustable punch pad coupled to the punch and including a receiving surface for receiving the punch pin, the receiving surface being substantially planar; and
an actuator coupled to the punch pad and operable to move the punch pad.

2. The punch of claim 1, wherein the punch pin is a hollow punch pin.

3. The punch of claim 1, wherein the punch pad is manually adjustable.

4. The punch of claim 1, wherein the punch pad is automatically adjustable.

5. The punch of claim 1, wherein the actuator includes an adjustment bar that cooperates with the punch pad.

6. The punch of claim 5, wherein the adjustment bar is coupled to a sliding lever, and wherein sliding the lever results in movement of the adjustment bar.

7. The punch of claim 5, further comprising a spring that biases the adjustment bar such that after the punch pad is moved in a first direction, the adjustment bar is disengaged from the punch pad such that the punch pad does not move in a second direction opposite the first direction.

8. The punch of claim 1, wherein the punch pad is movable in a substantially circular motion.

9. The punch of claim 1, wherein the punch pad is movable in predetermined increments in a first direction.

10. The punch of claim 1, wherein the punch includes multiple punch heads.

11. The punch of claim 1, wherein the receiving surface lies in a plane that is substantially perpendicular to the movement of the punch pin.

12. The punch of claim 1, further comprising a stop member coupled to the punch pad.

13. A punch comprising:
a base;
a punch head coupled to the base, the punch head including a punch pin configured to move in a punching direction;
an adjustable punch pad coupled to the punch, the adjustable punch pad including a receiving surface movable in a plane that is perpendicular to the movement of the punch pin; and
an actuator coupled to the punch pad to move the punch pad.

14. The punch of claim 13, wherein the punch pin is a hollow punch pin.

15. The punch of claim 13, wherein the punch pad is manually adjustable.

16. The punch of claim 13, wherein the punch pad is automatically adjustable.

17. The punch of claim 13, wherein the actuator includes an adjustment bar that cooperates with the punch pad.

18. The punch of claim 17, wherein the adjustment bar is coupled to a sliding lever, and wherein sliding the lever results in movement of the adjustment bar.

19. The punch of claim 17, further comprising a spring that biases the adjustment bar such that after the punch pad is moved in a first direction, the adjustment bar is disengaged from the punch pad such that the punch pad does not move in a second direction opposite the first direction.

20. The punch of claim 13, wherein the punch pad is movable in a substantially circular motion.

21. The punch of claim 13, wherein the punch pad is movable in predetermined increments in a first direction.

22. The punch of claim 13, wherein the punch includes multiple punch heads.

23. The punch of claim 13, wherein the receiving surface is substantially planar.

24. The punch of claim 13, further comprising a stop member coupled to the punch pad.

25. A punch comprising:
a base;
a plurality of punch heads coupled to the base, each punch head including a punch pin configured to move in a punching direction;
a plurality of adjustable punch pads mounted on the punch, each of the adjustable punch pads including a receiving surface for receiving a respective punch pin; and
an actuator coupled to the adjustable punch pads to move each of the plurality of punch pads.

26. The punch of claim 25, wherein the actuator is operable to move the plurality of punch pads simultaneously.

27. The punch of claim 25, wherein the punch pin is a hollow punch pin.

28. The punch of claim 25, wherein the receiving surfaces are substantially planar.

29. The punch of claim 25, wherein the actuator is manually operable.

30. The punch of claim 25, wherein the actuator is automatically operable.

31. The punch of claim 25, wherein the actuator includes an adjustment bar that cooperates with the punch pads.

32. The punch of claim 31, wherein the adjustment bar is coupled to a sliding lever, and wherein sliding the lever results in movement of the adjustment bar.

33. The punch of claim 31, further comprising a spring that biases the adjustment bar such that after the at least one punch pad is moved in the first direction, the adjustment bar is disengaged from the at least one punch pad such that the at least one punch pad does not move in a second direction opposite the first direction.

34. The punch of claim 25, wherein the punch pads are movable in a substantially circular motion.

35. The punch of claim 25, wherein the punch pads are movable in predetermined increments in a first direction.

36. The punch of claim 25, wherein the punch includes three punch heads and three punch pads.

37. The punch of claim 25, further comprising a stop member coupled to the punch pads.
